(19) United States
(12) Patent Application Publication
(10) Pub. No.: US 2025/0370093 A1
(43) Pub. Date: Dec. 4, 2025

(54) PULSE RADAR DEVICE AND OPERATING METHOD OF PULSE RADAR DEVICE

(71) Applicant: ELECTRONICS AND TELECOMMUNICATIONS RESEARCH INSTITUTE, Daejeon (KR)

(72) Inventors: Young-deuk JEON, Daejeon (KR); Yi-Gyeong KIM, Daejeon (KR); Kyung Hwan PARK, Daejeon (KR); MIN-HYUNG CHO, Daejeon (KR)

(21) Appl. No.: 19/211,512

(22) Filed: May 19, 2025

(30) Foreign Application Priority Data
May 31, 2024 (KR) 10-2024-0071889
Apr. 23, 2025 (KR) 10-2025-0053004

(51) Int. Cl. G01S 7/292; G01S 13/02

(52) U.S. Cl. CPC G01S 7/2926; G01S 7/2927; G01S 13/0209

(57) ABSTRACT

A pulse radar device for performing a signal processing operation is provided, which includes a transmitting unit that radiates a transmission signal, a receiving unit that receives a reception signal from a target, and a signal processing unit that generates output codes based on the reception signal. The signal processing unit includes a plurality of integrators that generate integration signals based on the reception signal, a plurality of analog-to-digital converters (ADCs) that generate the output codes based on the integration signals, a clock controller that provides clock signals to the plurality of integrators and the plurality of ADCs, a voltage generator that applies an adaptive reference voltage to the plurality of ADCs, and a controller that determines whether to repeat the signal processing operation based on the output codes and the threshold value.

### CROSS-REFERENCE TO RELATED APPLICATIONS

This application claims priority under 35 U.S.C. § 119 to Korean Patent Application No. 10-2024-0071889 filed on May 31, 2024, and Korean Patent Application No. 10-2025-0053004 filed on Apr. 23, 2025 in the Korean Intellectual Property Office, the disclosures of which are incorporated by reference herein in their entireties.

### BACKGROUND

### 1. Field of the Invention

Embodiments of the present disclosure described herein relate to a pulse radar device, and more particularly, relate to a pulse radar device and a method of operating the pulse radar device that perform a signal processing operation using a low-resolution analog-to-digital converter and an adaptive reference voltage.

### 2. Description of Related Art

A radar device is a device for transmitting radio waves and analyzing reflected waves or backscattered waves reflected back from an object to detect the presence or absence of a target, a distance, a speed, a moving direction, and the like. In the case of a target with a large distance or a target with a small reflection area, a reflected signal is weak, and thus the radar device has a limit in detecting the signal.

On the other hand, an ultra wide band (UWB) radar device is utilized to detect the presence of a person behind an obstacle or a person buried under a building in a disaster situation by using the penetrability of radio waves. At this time, there is a need for a signal processing technology capable of detecting minute signals reflected by the person.

Recently, radar devices have used various methods to detect minute signals. However, a method of increasing the number of integrations for a reception signal has the problem of increasing the signal processing time, and a method of using a high-resolution analog-to-digital converter has the problem of hardware complexity because it requires complex signal processing circuit.

### SUMMARY OF THE INVENTION

Embodiments of the present disclosure provide a pulse radar and a method for operating the pulse radar device that perform a signal processing operation using a low-resolution analog-to-digital converter and an adaptive reference voltage, so as to minimize an area of hardware and optimize a signal processing time.

According to an embodiment of the present disclosure, a pulse radar device for performing a signal processing operation includes a transmitting unit that radiates a transmission signal, a receiving unit that receives a reception signal from a target, and a signal processing unit that generates output codes based on the reception signal. The signal processing unit includes a plurality of integrators that generate integration signals based on the reception signal, a plurality of analog-to-digital converters (ADCs) that generate the output codes based on the integration signals, a clock controller that provides clock signals to the plurality of integrators and the plurality of ADCs, a voltage generator that applies an adaptive reference voltage to the plurality of ADCs, and a controller that determines whether to repeat the signal processing operation based on the output codes and the threshold value.

According to an embodiment of the present disclosure, the controller determines to stop the signal processing operation in response to at least one of the output codes being greater than or equal to the threshold value, and determines to repeat the signal processing operation in response to the output codes being less than the threshold value.

According to an embodiment of the present disclosure, magnitude of the adaptive reference voltage decreases at an attenuation ratio each time the signal processing operation is repeated.

According to an embodiment of the present disclosure, each of the plurality of ADCs is a 3-bit or 4-bit low-resolution ADC.

According to an embodiment of the present disclosure, the plurality of integrators include a first integrator. The plurality of ADCs include a first ADC. The clock controller outputs a first trigger signal. The transmitting unit radiates a first transmission signal based on the first trigger signal during a first period. The receiving unit receives a first reception signal during the first period. The first integrator samples the first reception signal and generates a first integration signal based on the sampled first reception signal during the first period. The first ADC converts the first integration signal to generate a first output code during the first period.

According to an embodiment of the present disclosure, the clock signals include a first integrator clock signal for the first integrator and a first ADC clock signal for the first ADC. The first integrator samples the first reception signal at a first falling edge of the first integrator clock signal. The first ADC converts the first integration signal during a first high-level interval of the first ADC clock signal.

According to an embodiment of the present disclosure, the controller outputs a second trigger signal in response to the first output code being less than the threshold value. The transmitting unit radiates a second transmission signal based on the second trigger signal during a second period. The receiving unit receives the second reception signal during the second period. The first integrator samples the second reception signal, and accumulates the sampled second reception signal and the first integration signal to generate a second integration signal during the second period. The first ADC outputs a second output code based on the second integration signal.

According to an embodiment of the present disclosure, the first integrator samples the second reception signal at a second falling edge of the first integrator clock signal, and accumulates the sampled second reception signal and the first integration signal after the second falling edge. The first ADC converts the second integration signal during a second high-level interval of the first ADC clock signal.

According to an embodiment of the present disclosure, the clock signals have the same pulse width.

According to an embodiment of the present disclosure, the plurality of integrators include a second integrator. The clock signals include a second integrator clock signal for the second integrator. The first integrator clock signal and the second integrator clock signal differ in time by a clock delay value.

According to an embodiment of the present disclosure, the controller sets values of one or more parameters associated with the signal processing operation prior to performing the signal processing operation.

According to an embodiment of the present disclosure, the one or more parameters include at least one of first to seventh parameters. The first parameter represents an initial voltage value of the adaptive reference voltage. The second parameter represents the threshold value, The third parameter represents the attenuation ratio. The fourth parameter represents the pulse width. The fifth parameter represents the clock delay value. The sixth parameter represents a cycle of the transmission signal. The seventh parameter represents a time difference between the transmission signal and the first integrator clock signal.

According to an embodiment of the present disclosure, the first period and the second period correspond to the cycle.

According to an embodiment of the present disclosure, a method of operating pulse radar device includes performing a signal processing operation and determining whether to repeat the signal processing operation. The performing of the signal processing operation includes applying, by a voltage generator, an adaptive reference voltage to a plurality of analog-to-digital converters (ADCs), radiating, by a transmitting unit, a first transmission signal toward a target, receiving, by a receiving unit, a first reception signal from the target, generating, by a plurality of integrators, integration signals based on the first reception signal, and generating, by the plurality of ADCs, output codes based on the integration signals.

According to an embodiment of the present disclosure, the determining of whether to repeat the signal processing operation is based on the output codes and the threshold value.

According to an embodiment of the present disclosure, the plurality of integrators include a first integrator. The plurality of ADCs include a first ADC. The generating of the integration signals based on the first reception signal by the plurality of integrators includes sampling, by the first integrator, the first reception signal to generate a first integration signal. The generating of the output codes based on the integration signals by the plurality of ADCs includes converting, by the first ADC, the first integration signal to generate a first output code.

According to an embodiment of the present disclosure, the determining of whether to repeat the signal processing operation includes comparing, by the controller, the first output code and the threshold value.

According to an embodiment of the present disclosure, the method further includes applying, by the voltage generator, the adaptive reference voltage having the magnitude based on an attenuation ratio to the plurality of ADCs in response to determining to repeat the signal processing operation, radiating, by the transmitting unit, a second transmission signal towards the target, receiving, by the receiving unit, a second reception signal from the target, generating, by the first integrator, a second integration signal based on the second reception signal, and converting, by the first ADC, the second integration signal to generate a second output code.

According to an embodiment of the present disclosure, the generating of the second integration signal based on the second reception signal by the first integrator includes sampling the second reception signal, and accumulating the sampled second reception signal and the first integration signal.

According to an embodiment of the present disclosure, the method further includes setting values of one or more parameters prior to performing the signal processing operation.

### BRIEF DESCRIPTION OF THE DRAWINGS

The above and other objects and features of the present disclosure will become apparent by describing in detail embodiments thereof with reference to the accompanying drawings.

FIG. 1 illustrates a pulse radar device, according to an embodiment of the present disclosure.

FIG. 2 illustrates an example of a pulse radar device, according to an embodiment of the present disclosure.

FIG. 3 illustrates an example of the signal processing unit of FIG. 1.

FIG. 4 illustrates an example of a signal processing operation of a pulse radar device, according to an embodiment of the present disclosure.

FIG. 5 illustrates an example of an adaptive reference voltage, according to an embodiment of the present disclosure.

FIG. 6 illustrates an example of a signal processing operation in terms of the first integrator and the first ADC of FIG. 3.

FIG. 7 illustrates an example of a method of operating a pulse radar device, according to an embodiment of the present disclosure.

### DETAILED DESCRIPTION OF THE INVENTION

Hereinafter, embodiments of the present disclosure may be described in detail and clearly to such an extent that an ordinary one in the art easily implements the present disclosure.

Components that are described in the detailed description with reference to the terms “unit”, “module”, “block”, “˜er or ˜or”, etc. and function blocks illustrated in drawings will be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

In the present disclosure, each of the phrases such as “A or B,” “at least one of A and B,” “at least one of A or B,” “A, B, or C,” “at least one of A, B, and C,” and “at least one of A, B, or C” is intended to encompass any one of the listed elements and all possible combinations thereof.

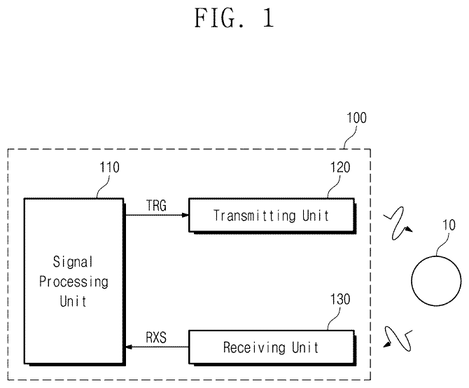

FIG. 1 illustrates a pulse radar device, according to an embodiment of the present disclosure.

Referring to FIG. 1, a pulse radar device 100 may include a signal processing unit 110, a transmitting unit 120, and a receiving unit 130.

The signal processing unit 110 may generate a trigger signal TRG used to generate a transmission signal (e.g., a transmission pulse) in the transmitting unit 120. The signal processing unit 110 may transmit the trigger signal TRG to the transmitting unit 120.

The signal processing unit 110 may receive a reception signal RXS (e.g., an echo pulse) from the receiving unit 130. The signal processing unit 110 may perform a signal processing operation on the reception signal RXS received from the receiving unit 130. The signal processing unit 110 may acquire an information on a target 10 based on a signal obtained as a result of the signal processing operation. In an embodiment, the information on the target 10 may include the presence or absence of the target 10, a distance between the pulse radar 100 and the target 10, a speed of the target 10, a moving direction of the target 10, and the like.

In an embodiment, the signal processing unit 110 may generate a reception clock signal. The signal processing unit 110 may transmit the reception clock signal to the receiving unit 130. The receiving unit 130 may receive the reception signal RXS based on the reception clock signal. In an embodiment, the signal processing unit 110 may transmit the trigger signal TRG to the transmitting unit 120, and then transmit the reception clock signal to the receiving unit 130. In this case, a time difference between a transmission time point of the trigger signal TRG and a transmission time point of the reception clock signal may be related to a distance between the pulse radar device 100 and the target 10.

The transmitting unit 120 may receive the trigger signal TRG from the signal processing unit 110. The transmitting unit 120 may radiate the transmission signal to the target 10 based on the trigger signal TRG.

In an embodiment, the transmitting unit 120 may include one or more transmitters. Each of the one or more transmitters may radiate the transmission signal through a transmitting antenna.

The receiving unit 130 may receive the reception signal RXS from the target 10. The reception signal RXS may represent a signal in which a transmission signal is reflected by the target 10. The receiving unit 130 may transmit the reception signal RXS to the signal processing unit 110.

In an embodiment, the receiving unit 130 may include one or more receivers. Each of the one or more receivers may receive the reception signal RXS through a receiving antenna.

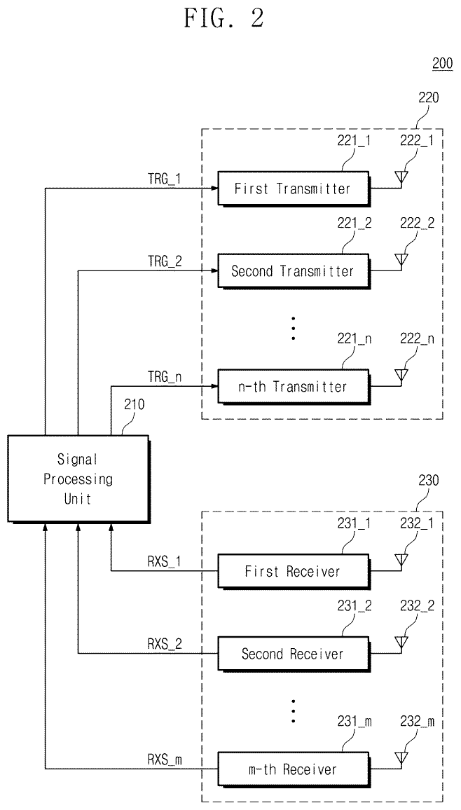

FIG. 2 illustrates an example of a pulse radar device, according to an embodiment of the present disclosure.

Referring to FIG. 2, a pulse radar device 200 may include a signal processing unit 210, a transmitting unit 220, and a receiving unit 230.

In FIG. 2, the signal processing unit 210 may correspond to the signal processing unit 110 of FIG. 1, the transmitting unit 220 may correspond to the transmitting unit 120 of FIG. 1, and the receiving unit 230 may correspond to the receiving unit 130 of FIG. 1. In the following, for convenience of description, redundant descriptions are omitted.

The transmitting unit 220 may include first to n-th transmitters 221_1 to 221_n (where n is a natural number greater than 1). The first to nth transmitters 221_1 to 221_n may radiate transmission signals through first to nth transmitting antennas 222_1 to 222_n.

For example, the first transmitter 221_1 may radiate a transmission signal through the first transmitting antenna 222_1 based on a trigger signal TRG_1 received from the signal processing unit 210. The second transmitter 221_2 may radiate a transmission signal through the second transmitting antenna 222_2 based on a trigger signal TRG_2 received from the signal processing unit 210. Similarly, the n-th transmitter 221_n may radiate a transmission signal through the n-th transmitting antenna 222_n based on a trigger signal TRG_n received from the signal processing unit 210.

In an embodiment, the first to nth transmitters 221_1 to 221_n may radiate the same transmission signal.

In an embodiment, the first to nth transmitters 221_1 to 221_n may radiate different transmission signals.

The receiving unit 230 may include first to m-th receivers 231_1 to 231_m (where m is a natural number greater than 1). The first to m-th receivers 231_1 to 231_m may receive a plurality of reception signals RXS_1 to RXS_m through first to m-th receiving antennas 232_1 to 232_m.

For example, the first receiver 231_1 may receive the reception signal RXS_1 through the first receiving antenna 232_1. The second receiver 231_2 may receive the reception signal RXS_2 through the second receiving antenna 232_2. Similarly, the m-th receiver 231_m may receive the reception signal RXS_m through the m-th receiving antenna 232_m.

The signal processing unit 210 may receive the plurality of reception signals RXS_1 to RXS_m from the receiving unit 230. For example, the signal processing unit 210 may receive the reception signal RXS_1 from the first receiver 231_1. The signal processing unit 210 may receive the reception signal RXS_2 from the second receiver 231_2. Similarly, the signal processing unit 210 may receive the reception signal RXS_m from the m-th receiver 231_m.

The signal processing unit 210 may perform a signal processing operation based on the plurality of reception signals RXS_1 to RXS_m.

In an embodiment, the transmitting unit 220 may radiate a single transmission signal. In this case, the receiving unit 230 receives the plurality of reception signals RXS_1 to RXS_m associated with the single transmission signal, and the signal processing unit 210 performs the signal processing operation based on the plurality of reception signals RXS_1 to RXS_m, thereby improving signal detection performance.

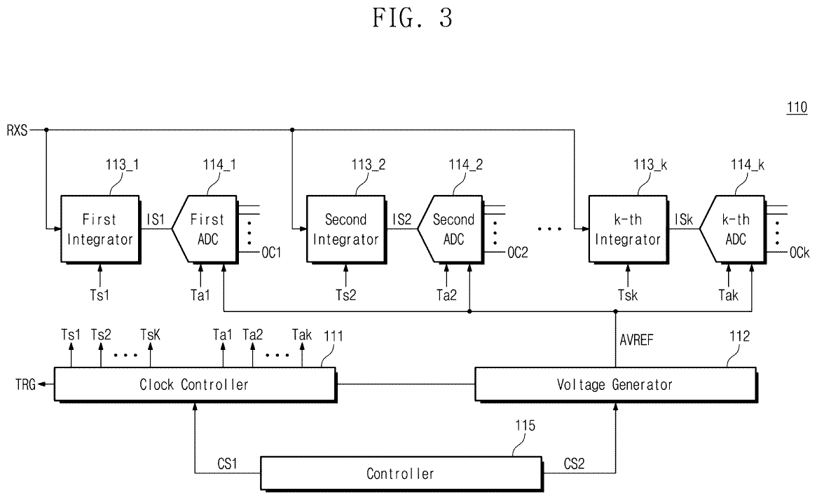

FIG. 3 illustrates an example of the signal processing unit of FIG. 1.

Referring to FIGS. 1 and 3, the signal processing unit 110 may include a clock controller 111, a voltage generator 112, a plurality of integrators 113_1 to 113_k (where k is a natural number greater than 1), a plurality of analog-to-digital converters (ADCs) 114_1 to 114_k, and a controller 115.

The clock controller 111 may output a plurality of integrator clock signals Ts1 to Tsk for the plurality of integrators 113_1 to 113_k and a plurality of ADC clock signals Ta1 to Tak for the plurality of ADCs 114_1 to 114_k. The clock controller 111 may transmit the plurality of integrator clock signals Ts1 to Tsk to the plurality of integrators 113_1 to 113_k, and transmit the plurality of ADC clock signals Ta1 to Tak to the plurality of ADCs 114_1 to 114_k.

The clock controller 111 may transmit the trigger signal TRG to the transmitting unit 120.

The voltage generator 112 may apply an adaptive reference voltage AVREF to the plurality of ADCs 114_1 to 114_k. The voltage generator 112 may decrease the magnitude of the adaptive reference voltage AVREF according to an attenuation ratio each time the signal processing operation of the pulse radar device 100 is repeated.

The plurality of integrators 113_1 to 113_k may receive the reception signal RXS from the receiving unit 130. The plurality of integrators 113_1 to 113_k may receive the plurality of integrator clock signals Ts1 to Tsk, respectively. The plurality of integrators 113_1 to 113_k may generate integration signals IS1 to ISk based on the plurality of integrator clock signals Ts1 to Tsk and the reception signal RXS.

For example, the first integrator 113_1 may generate the integration signal IS1 based on the reception signal RXS in response to the integrator clock signal Ts1. The second integrator 113_2 may generate the integration signal IS2 based on the reception signal RXS in response to the integrator clock signal Ts2. Similarly, the k-th integrator 113_k may generate the integration signal ISk based on the reception signal RXS in response to the integrator clock signal Tsk.

In an embodiment, when the reception signal RXS is an initial reception signal, the plurality of integrators 113_1 to 113_k may sample the reception signal RXS to generate the integration signals IS1 to ISk. For example, the first integrator 113_1 may sample the reception signal RXS to generate the integration signal IS1. The second integrator 113_2 may sample the reception signal RXS to generate the integration signal IS2. Similarly, the k-th integrator 113_k may sample the reception signal RXS to generate the integration signal ISk.

In an embodiment, when the reception signal RXS is not an initial reception signal, each of the plurality of integrators 113_1 to 113_k may sample the reception signal RXS, and accumulate the sampled reception signal RXS and the previous integration signal to generate a current integration signal. For example, the first integrator 113_1 may sample the reception signal RXS, and accumulate the sampled reception signal RXS and the previous integration signal to generate the integration signal IS1. The second integrator 113_2 may sample the reception signal RXS, and accumulate the sampled reception signal RXS and the previous integration signal to generate the integration signal IS2. Similarly, the k-th integrator 113_k may sample the reception signal RXS, and accumulate the sampled reception signal RXS and the previous integration signal to generate the integration signal ISk.

The plurality of integrators 113_1 to 113_k may transmit the plurality of integration signals IS1 to ISk to the plurality of ADCs 114_1 to 114_k, respectively.

In an embodiment, each of the integration signals IS1 to ISk may be a voltage signal. In addition, the sampled reception signal RXS may be a voltage signal.

The plurality of ADCs 114_1 to 114_k may receive integration signals IS1 to ISk from the plurality of integrators 113_1 to 113_k, respectively. The plurality of ADCs 114_1 to 114_k may receive the plurality of ADC clock signals Ta1 to Tak from the clock controller 111, respectively. The plurality of ADCs 114_1 to 114_k may receive the adaptive reference voltage AVREF from the voltage generator 112. The plurality of ADCs 114_1 to 114_k may generate output codes OC1 to OCk that are digital signals based on the integration signals IS1 to ISk, the plurality of ADC clock signals Ta1 to Tak, and the adaptive reference voltage AVREF.

For example, the first ADC 114_1 may convert the integration signal IS1 to generate the output code OC1 in response to the ADC clock signal Ta1 and the adaptive reference voltage AVREF. The second ADC 114_2 may convert the integration signal IS2 to generate the output code OC2 in response to the ADC clock signal Ta2 and the adaptive reference voltage AVREF. Similarly, the k-th ADC 114_k may convert the integration signal ISk to generate the output code OCk in response to the ADC clock signal Tak and the adaptive reference voltage AVREF.

The plurality of ADCs 114_1 to 114_k may transmit the output codes OC1 to OCk to the controller 115.

In an embodiment, each of the plurality of ADCs 114_1 to 114_k may be a low-resolution ADC. For example, each of the plurality of ADCs 114_1 to 114_k may be a low-resolution ADC having a resolution of 3 bits or 4 bits.

The controller 115 may control the overall operation of the signal processing unit 110. For example, the controller 115 may transmit a first control signal to the clock controller 111 to control the clock controller 111. The controller 115 may transmit a second control signal to the voltage generator 112 to control the voltage generator 112.

The controller 115 may determine whether to repeat the signal processing operation based on the output codes OC1 to OCk received from the plurality of ADCs 114_1 to 114_k.

For example, the controller 115 may compare the output codes OC1 to OCk and a threshold value. When at least one of the output codes OC1 to OCk is greater than or equal to the threshold value, the controller 115 may determine to stop the signal processing operation. When the output codes OC1 to OCk are less than the threshold value, the controller 115 may determine to repeat the signal processing operation.

As described above, the controller 115 may determine to repeat the signal processing operation of the pulse radar device 100 until at least one of the output codes OC1 to OCk reaches the threshold value. The pulse radar device 100 may detect a minute signal and optimize a signal processing time by using a low-resolution ADC and the adaptive reference voltage AVREF, the magnitude of which decreases each time the signal processing operation is repeated.

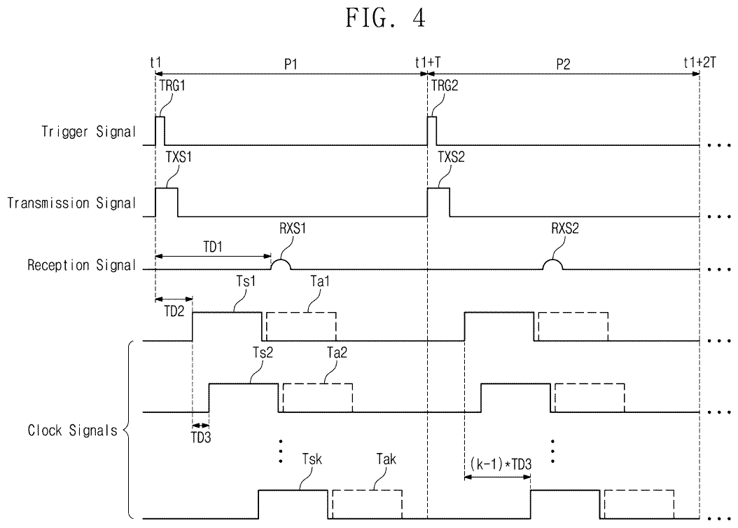

FIG. 4 illustrates an example of a signal processing operation of a pulse radar device, according to an embodiment of the present disclosure.

Referring to FIGS. 1, 3, and 4, the pulse radar device 100 may perform a signal processing operation based on a trigger signal and clock signals.

In FIG. 4, it is assumed that a first trigger signal TRG1 represents an initial trigger signal, a first transmission signal TXS1 represents an initial transmission signal, and a first reception signal RXS1 represents an initial reception signal.

In FIG. 4, it is assumed that a time point at which the clock controller 111 outputs the first trigger signal TRG1 and a time point at which the transmitting unit 120 radiates the first transmission signal TXS1 are the same as a first time point t1.

In FIG. 4, it is assumed that a cycle T represents a cycle of a transmission signal, and a first period P1 and a second period P2 correspond to the cycle T.

In FIG. 4, it is assumed that pulse widths of the integrator clock signals Ts1 to Tsk are all the same.

In FIG. 4, each of the clock signals Ts1 to Tsk and Ta1 to Tak may periodically have a logic low value or a logic high value. The logic high value and the logic low value may each correspond to a magnitude of a particular voltage. In the clock signals Ts1 to Tsk and Ta1 to Tak, an interval having a logic low value may be referred to as a low-level interval, and an interval having a logical high value may be referred as a high-level interval.

During the first period P1, the pulse radar device 100 may perform the signal processing operation. For example, the transmitting unit 120 may radiate the first transmission signal TXS1 in response to the first trigger signal TRG1.

The receiving unit 130 may receive the first reception signal RXS1 after a first time delay value TD1 passes from the first time point t1.

In an embodiment, the first time delay value TD1 may be set based on Equation 1 below.

$$T D 1 = \frac{2 d}{c} \qquad [ Equation 1 ]$$

In Equation 1, d may represent a distance from the target 10, and c may represent a propagation speed of a signal.

After a second time delay value TD2 passes from the first time point t1, the clock controller 111 may sequentially output the plurality of integrator clock signals Ts1 to Tsk. In an embodiment, the second time delay value TD2 may be less than the first time delay value TD1.

The clock controller 111 may output the plurality of integrator clock signals Ts1 to Tsk at intervals of a third time delay value TD3, and may output the plurality of ADC clock signals Ta1 to Tak at intervals of the third time delay value TD3. In an embodiment, the third time delay value TD3 may correspond to a clock delay value between adjacent integrator clock signals.

The first integrator 113_1 may sample the first reception signal RXS1 at a falling edge of the integrator clock signal Ts1 in the first period P1, and generate the integration signal IS1 corresponding to the first period P1 based on the sampled first reception signal RXS1. Then, the first ADC 114_1 may convert the integration signal IS1 corresponding to the first period P1 to generate the output code OC1 corresponding to the first period P1 during a high-level interval of the ADC clock signal Ta1 in the first period P1.

The second integrator 113_2 may sample the first reception signal RXS1 at a falling edge of the integrator clock signal Ts2 in the first period P1, and generate the integration signal IS2 corresponding to the first period P1 based on the sampled first reception signal RXS1. Then, the second ADC 114_2 may convert the integration signal IS2 corresponding to the first period P1 to generate the output code OC2 corresponding to the first period P1 during the high-level interval of the ADC clock signal Ta2 in the first period P1.

Similarly, the k-th integrator 113_k may sample the first reception signal RXS1 at a falling edge of the integrator clock signal Tsk in the first period P1, and generate the integration signal ISk corresponding to the first period P1 based on the sampled first reception signal RXS1. Then, the k-th ADC 114_k may convert the integration signal ISk corresponding to the first period P1 to generate the output code OCk corresponding to the first period P1 during the high-level interval of the ADC clock signal Tak in the first period P1.

The controller 115 may determine whether to repeat the signal processing operation based on the output codes OC1 to OCk corresponding to the first period P1 and the threshold value.

In response to determining to repeat the signal processing operation, the pulse radar device 100 may perform the signal processing operation during the second period P2. However, since the second reception signal RXS2 is not an initial reception signal, the plurality of integrators 113_1 to 113_k may operate differently from that in the first period P1.

For example, the first integrator 113_1 may sample the second reception signal RXS2 at a falling edge of the integrator clock signal Ts1 in the second period P2, and accumulate the sampled second reception signal RXS2 and the integration signal IS1 corresponding to the first period P1 to generate the integration signal IS1 corresponding to the second period P2.

The second integrator 113_2 may sample the second reception signal RXS2 at a falling edge of the integrator clock signal Ts2 in the second period P2, and accumulate the sampled second reception signal RXS2 and the integration signal IS2 corresponding to the first period P1 to generate the integration signal IS2 corresponding to the second period P2.

Similarly, the k-th integrator 113_k may sample the second reception signal RXS2 at a falling edge of the integrator clock signal Tsk in the second period P2, and accumulate the sampled second reception signal RXS2 and the integration signal ISk corresponding to the first period P1 to generate the integration signal ISk corresponding to the second period P2.

The plurality of ADCs 114_1 to 114_k may generate the output codes OC1 to OCk corresponding to the second period P2 based on the integration signals IS1 to ISk corresponding to the first period P2.

The controller 115 may determine whether to repeat the signal processing operation based on the output codes OC1 to OCk corresponding to the second period P2 and the threshold value.

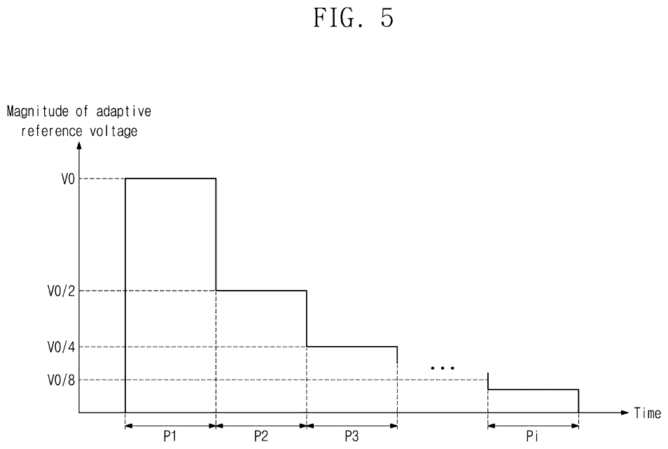

FIG. 5 illustrates an example of an adaptive reference voltage according to an embodiment of the present disclosure.

In FIG. 5, the horizontal axis may represent time, and the vertical axis may represent the magnitude of the adaptive reference voltage AVREF.

In FIG. 5, it is assumed that an initial value of the adaptive reference voltage AVREF is ‘V0’. In FIG. 5, it is assumed that an attenuation ratio of the adaptive reference voltage AVREF is ‘1/2’. Further, in FIG. 5, it is assumed that an i-th period Pi is a period in which the last signal processing operation is performed.

Referring to FIGS. 3-5, the voltage generator 112 may decrease the magnitude of the adaptive reference voltage AVREF according to the attenuation ratio each time the signal processing operation is repeated. For example, during the first period P1, the magnitude of the adaptive reference voltage AVREF may be ‘V0’. During the second period P2, the magnitude of the adaptive reference voltage AVREF may be ‘V0/2’. During the third period P3, the magnitude of the adaptive reference voltage AVREF may be ‘V0/4’. As such, the magnitude of the adaptive reference voltage AVREF may be decreased according to the attenuation ratio until the i-th period Pi in which the last signal processing operation is performed.

As described above, when using the adaptive reference voltage AVREF that decreases in magnitude, a resolution of a low-resolution ADC may increase.

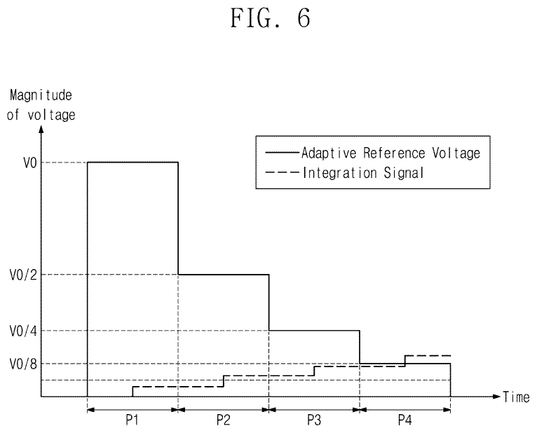

FIG. 6 illustrates an example of a signal processing operation in terms of the first integrator and the first ADC of FIG. 3.

In FIG. 6, it is assumed that the horizontal axis represents time and the vertical axis represents the magnitude of voltage.

In FIG. 6, it is assumed that an initial value of an adaptive reference voltage AVREF is ‘V0’.

In FIG. 6, it is assumed that an attenuation ratio of the adaptive reference voltage AVREF is ‘1/2’.

In FIG. 6, it is assumed that the first ADC 114_1 of FIG. 3 is a 3-bit ADC.

In FIG. 6, it is assumed that the first integrator 113_1 of FIG. 3 samples a signal at the same time as the first reception signal RXS1.

In FIG. 6, it is assumed that a threshold value is ‘4’.

Referring to FIGS. 3, 4, and 6, the output code CS1 of the first ADC 114_1 may be determined based on 1 least significant bit (LSB) voltage of the first ADC 114_1.

The 1 LSB voltage of the first ADC 114_1 may be determined based on Equation 2 below.

$$1 L S B voltage = \frac{A V REF}{{2}^{p}} \qquad [ Equation 2 ]$$

In Equation 2, p may represent the number of bits of the ADC.

Referring to FIG. 6, during a first period P1, the first integrator 113_1 may generate the integration signal IS1 based on the first reception signal RXS1. During the first period P1, the magnitude of the adaptive reference voltage AVERF may be ‘V0’, and the value of the integration signal IS1 may be less than or equal to ‘V0/8’, which is 1 LSB voltage of the first ADC 114_1, so that the output codes CS1 to CSk of the plurality of ADCs 114_1 to 114_k may be ‘0’. That is, since the output codes CS1 to CSk may be less than the threshold value, it may not be possible to detect a signal in the first period P1.

During the second period P2, the first integrator 113_1 may generate the integration signal IS1 based on the second reception signal RXS2 having the same magnitude and timing as the first reception signal RXS1. During the second period P2, the magnitude of the adaptive reference voltage AVERF may be ‘V0/2’, and the 1 LSB voltage of the ADC 114_1 may be ‘VO/16’, so that the output code CS1 of the first ADC 114_1 may be ‘1’. Since the output code CS1 may be less than the threshold value, it may not be possible to detect a signal in the second period P2.

Similarly, during the third period P3, the output code CS1 may be ‘3’. Since the output code CS1 may be less than the threshold value, it may not be possible to detect a signal in the third period P3.

During the fourth period P4, the output code CS1 may be ‘7’. Since the output code CS1 may be greater than or equal to the threshold value, a signal is detected in the fourth period P4, and the signal processing operation may be stopped.

As described above, each time the signal processing operation is repeated, the SNR of the integration signal IS1 output from the first integrator 113_1 increases, and the magnitude of the adaptive reference voltage AVREF decreases, so that even when a 3-bit ADC is used, a minute signal may be detected for a short time.

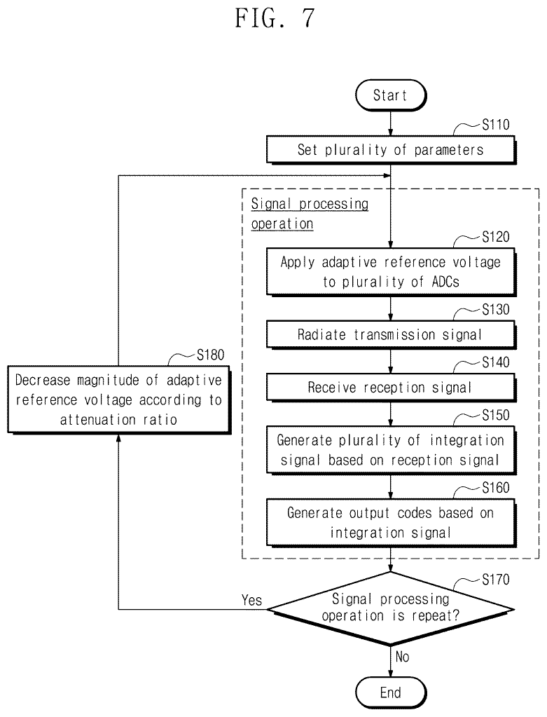

FIG. 7 illustrates an example of a method of operating a pulse radar device, according to an embodiment of the present disclosure.

Referring to FIGS. 1, 3, and 7, in operation S110, the controller 115 may set values of one or more parameters associated with a signal processing operation. In an embodiment, the one or more parameters may include at least one of a first parameter representing an initial value of the adaptive reference voltage AVREF, a second parameter representing a threshold value, a third parameter representing an attenuation ratio, a fourth parameter representing a pulse width of the clock signals Ts1 to Tsk and Ta1 to Tak, a fifth parameter representing a clock delay value (e.g., the third time delay value TD3 in FIG. 4) between the integrator clock signals Ts1 to Tsk, a sixth parameter representing a cycle of a transmission signal, and a seventh parameter representing a time difference (e.g., the second time delay value TD2 in FIG. 4) between the transmission signal and the first integrator clock signal Ts1.

In operation S120, the voltage generator 112 may apply the adaptive reference voltage AVREF to the plurality of ADCs 114_1 to 114_k.

In operation S130, the transmitting unit 120 may radiate a transmission signal toward the target 10. For example, the transmitting unit 120 may radiate the transmission signal based on the trigger signal TRG received from the clock controller 111.

In operation S140, the receiving unit 130 may receive the reception signal RXS from the target 10.

In operation S150, the plurality of integrators 113_1 to 113_k may generate the plurality of integration signals IS1 to ISk based on the reception signal RXS. For example, the plurality of integrators 113_1 to 113_k may sample the reception signal RXS and generate the integration signals IS1 to ISk based on the sampled reception signal RXS.

In operation S160, the plurality of ADCs 114_1 to 114_k may generate the output codes CS1 to CSk based on the integration signals IS1 to ISk. For example, the plurality of ADCs 114_1 to 114_k may convert the integration signals IS1 to ISk to generate output codes CS1 to CSk that are digital signals.

In operation S170, the controller 115 may determine whether to repeat the signal processing operation. For example, the controller 115 may determine whether to repeat the signal processing operation based on the output codes CS1 to CSk and the threshold value.

In response to determining to repeat the signal processing operation, in operation S180, the voltage generator 112 may decrease the magnitude of the adaptive reference voltage AVREF according to the attenuation ratio. Then, the pulse radar device 100 may repeatedly perform operations S120 to S170.

In the above embodiments, components according to the present disclosure are described by using the terms “first”, “second”, “third”, and the like. However, the terms “first”, “second”, “third”, and the like may be used to distinguish components from each other and do not limit the present disclosure. For example, the terms “first”, “second”, “third”, and the like do not involve an order or a numerical meaning of any form.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure.

According to the present disclosure, a pulse radar device can detect a high-speed UWB signal by minimizing hardware area and optimizing signal processing time.

What is claimed is:

1. A pulse radar device for performing a signal processing operation, comprising:
a transmitting unit configured to radiate a transmission signal;
a receiving unit configured to receive a reception signal from a target; and
a signal processing unit configured to generate output codes based on the reception signal,
wherein the signal processing unit includes:
a plurality of integrators configured to generate integration signals based on the reception signal;
a plurality of analog-to-digital converters (ADCs) configured to generate the output codes based on the integration signals;
a clock controller configured to provide clock signals to the plurality of integrators and the plurality of ADCs;
a voltage generator configured to apply an adaptive reference voltage to the plurality of ADCs; and
a controller configured to determine whether to repeat the signal processing operation based on the output codes and a threshold value.

2. The pulse radar device of claim 1, wherein the controller is configured to:
determine to stop the signal processing operation in response to at least one of the output codes being greater than or equal to the threshold value; and
determine to repeat the signal processing operation in response to the output codes being less than the threshold value.

3. The pulse radar device of claim 2, wherein magnitude of the adaptive reference voltage decreases at an attenuation ratio each time the signal processing operation is repeated.

4. The pulse radar device of claim 3, wherein each of the plurality of ADCs is a 3-bit or 4-bit low-resolution ADC.

5. The pulse radar device of claim 4, wherein the plurality of integrators include a first integrator,
wherein the plurality of ADCs include a first ADC,
wherein the clock controller outputs a first trigger signal,
wherein the transmitting unit radiates a first transmission signal based on the first trigger signal during a first period,
wherein the receiving unit receives a first reception signal during the first period,
wherein the first integrator samples the first reception signal and generates a first integration signal based on the sampled first reception signal during the first period, and
wherein the first ADC converts the first integration signal to generate a first output code during the first period.

6. The pulse radar device of claim 5, wherein the clock signals include a first integrator clock signal for the first integrator and a first ADC clock signal for the first ADC,
wherein the first integrator samples the first reception signal at a first falling edge of the first integrator clock signal, and
wherein the first ADC converts the first integration signal during a first high-level interval of the first ADC clock signal.

7. The pulse radar device of claim 6, wherein the controller outputs a second trigger signal in response to the first output code being less than the threshold value,
wherein the transmitting unit radiates a second transmission signal based on the second trigger signal during a second period,
wherein the receiving unit receives a second reception signal during the second period,
wherein the first integrator samples the second reception signal, and accumulates the sampled second reception signal and the first integration signal to generate a second integration signal during the second period, and
wherein the first ADC outputs a second output code based on the second integration signal.

8. The pulse radar device of claim 7, wherein the first integrator samples the second reception signal at a second falling edge of the first integrator clock signal, and accumulates the sampled second reception signal and the first integration signal after the second falling edge, and
wherein the first ADC converts the second integration signal during a second high-level interval of the first ADC clock signal.

9. The pulse radar device of claim 8, wherein the clock signals have the same pulse width.

10. The pulse radar device of claim 9, wherein the plurality of integrators include a second integrator,
wherein the clock signals include a second integrator clock signal for the second integrator, and
wherein the first integrator clock signal and the second integrator clock signal differ in time by a clock delay value.

11. The pulse radar device of claim 10, wherein the controller sets values of one or more parameters associated with the signal processing operation prior to performing the signal processing operation.

12. The pulse radar device of claim 11, wherein the one or more parameters include at least one of first to seventh parameters,
wherein the first parameter represents an initial voltage value of the adaptive reference voltage,
wherein the second parameter represents the threshold value,
wherein the third parameter represents the attenuation ratio,
wherein the fourth parameter represents the pulse width,
wherein the fifth parameter represents the clock delay value,
wherein the sixth parameter represents a cycle of the transmission signal, and
wherein the seventh parameter represents a time difference between the transmission signal and the first integrator clock signal.

13. The pulse radar device of claim 12, wherein the first period and the second period correspond to the cycle.

14. A method of operating a pulse radar device, the method comprising:
performing a signal processing operation; and
determining whether to repeat the signal processing operation,
wherein the performing of the signal processing operation includes:
applying, by a voltage generator, an adaptive reference voltage to a plurality of analog-to-digital converters (ADCs);
radiating, by a transmitting unit, a first transmission signal toward a target;
receiving, by a receiving unit, a first reception signal from the target;
generating, by a plurality of integrators, integration signals based on the first reception signal; and
generating, by the plurality of ADCs, output codes based on the integration signals.

15. The method of claim 14, wherein the determining of whether to repeat the signal processing operation is based on the output codes and a threshold value.

16. The method of claim 15, wherein the plurality of integrators include a first integrator,
wherein the plurality of ADCs include a first ADC,
wherein the generating of the integration signals based on the first reception signal by the plurality of integrators includes:
sampling, by the first integrator, the first reception signal to generate a first integration signal, and
wherein the generating of the output codes based on the integration signals by the plurality of ADCs includes:
converting, by the first ADC, the first integration signal to generate a first output code.

17. The method of claim 16, wherein the determining of whether to repeat the signal processing operation includes comparing, by a controller, the first output code and the threshold value.

18. The method of claim 17, further comprising:
applying, by the voltage generator, the adaptive reference voltage having the magnitude decreased based on an attenuation ratio to the plurality of ADCs in response to determining to repeat the signal processing operation;
radiating, by the transmitting unit, a second transmission signal toward the target;
receiving, by the receiving unit, a second reception signal from the target;
generating, by the first integrator, a second integration signal based on the second reception signal; and
converting, by the first ADC, the second integration signal to generate a second output code.

19. The method of claim 18, wherein generating of the second integration signal based on the second reception signal by the first integrator includes:
sampling the second reception signal; and
accumulating the sampled second reception signal and the first integration signal.

20. The method of claim 19, further comprising:
setting values of one or more parameters prior to performing the signal processing operation.
